(19) United States
(12) Patent Application Publication
(10) Pub. No.: US 2023/0305884 A1
(43) Pub. Date: Sep. 28, 2023

(54) METHODS AND SYSTEMS FOR DECENTRALIZED BLOCKCHAIN-SCHEDULED CONTAINER ORCHESTRATION, REPOSITORY AND CODE DEPLOYMENT WITH TOKENIZED TRACKING

(71) Applicant: DISTRIBUTED WEB OÜ, Tallinn (EE)

(72) Inventor: Emil DIMITROV, Tallinn (EE)

(21) Appl. No.: 17/701,505

(22) Filed: Mar. 22, 2022

(51) Int. Cl. G06F 9/48; G06F 9/50

(52) U.S. Cl. CPC G06F 9/4843; G06F 9/5077; G06F 2209/5011; G06F 2209/505

(57) ABSTRACT

Methods and systems for decentralized blockchain-scheduled container orchestration briefly described by term Geographically Distributed Container Orchestration System (GDCOS) are disclosed. They include a system for a decentralized blockchain-scheduled containerized stateful application, a method for decentralized scheduling, a method for decentralized container and code tracking and delivery.

The Geographically Distributed Container Orchestration System (GDCOS) is implemented through a distributed hybrid mesh network and blockchain controlled scheduling and resource allocation. The method for decentralized container and code tracking and delivery is implemented through a Non-Fungible Token (NFT) signed code, NFT-signed code repository, NFT-signed container images, and code deployment with tokenized tracking

### TECHNICAL FIELD

Embodiments of the present invention are in the field of blockchain-scheduled computer code application, code tracking and decentralized data delivery, and pertain particularly to methods and systems for decentralized web applications, container images, and data delivery through a distributed hybrid network, and more specifically Non-Fungible Token (NFT) signed code, NFT-signed code repository and NFT-signed container images.

### BACKGROUND OF THE INVENTION

Running computer applications in containers and methods for orchestrating containers in clusters of computing nodes are nowadays popular methods for hosting web-based applications. Various public and private cloud providers use this method for providing so-called serverless functions as a service (FaaS).

Container registries are widely used as methods for storing immutable images of containerized software that is used to deploy fast and with minimal effort a containerized application across multiple locations and environments. Container images, stored in the container registries, comprise of immutable layers containing scripts and program code. The usual method for collaborative development and consecutive storing and versioning of code are code repositories (e.g., Git), which are built to track code changes and versioning.

### SUMMARY OF THE INVENTION

Methods and systems for decentralized blockchain-scheduled container orchestration; decentralized blockchain-scheduled containerized stateful application; decentralized scheduling, decentralized container and code tracking and delivery; decentralized data storing, implemented through distributed hybrid mesh network and blockchain controlled scheduling and resource allocation; non-fungible token NFT (108) signed code; NFT-signed code repository; NFT-signed container images; and code deployment with tokenized tracking, briefly described by term Geographically Distributed Container Orchestration System (GDCOS).

More specifically, one embodiment of the present invention is a Method 1 - Method for a blockchain-coordinated scheduling of containers across multiple decentralized Container Orchestration Environments COE (103). The method defines few roles - COE (103) Owner and User. The method tracks the available unassigned computing resources (CPU, Memory, Storage, Network Bandwidth, Data Transfer) in each COE (103), and calculates the deployed containers and the resources (CPU, Memory, Storage, Network Bandwidth, Data Transfer) used by each container, and calculates the amount of digital tokens, needed to be paid to COE (103) owners in their associated token wallets. The User that orders execution of a container with predefined parameters (CPU, Memory, Storage, Network Bandwidth, Data Transfer) is charged for the services by deduction of digital tokens from their wallet, and blockchain assigns those tokens to the COE (103) owner’s token wallet, in accordance with the provided resources. The method features a decentralized, blockchain-coordinated built-in logging and alerting system that tracks the resources provided for each container scheduled to COE (103), and reports back to the blockchain. This functionality may be provided by Agent (104), as described below in the “Detailed Description of the Invention”.

Another implementation of the “methods and systems” is Method 2, that consists of Method 1 in combination with Non-Fungible Token Signed Code Repository (NFTSCR) (106), a code repository, in which the computer code is signed by a unique NFT (108). The NFT (108) serves for tracking of code execution. Tracking function may record code execution in every COE (103) and the consumed resources (CPU, Memory, Storage, Network Bandwidth, Data Transfer) in the previously described decentralized blockchain architecture. NFTSCR (106) owners may receive rewards in digital tokens according to the recorded execution. Furthermore, pieces of code, for example, a container image composer file, stored in the different NFTSCR (106), altogether may compose a container that has NFT as a unique identifier - Container Non-Fungible Token Signed (CNFTS) (107). Every code contributor and NFT (108) owner may create their own decentralized autonomous organization DAO (703) on top of the decentralized blockchain and may redistribute reward coins according to the DAO’s (703) articles of organization. This constitutes another embodiment of the invention.

### BRIEF DESCRIPTION OF THE DRAWINGS

The drawings are meant to illustrate the principles of the invention and do not limit the scope of the invention. The above-mentioned features and objects of the present disclosure will become more apparent with reference to the following description taken in conjunction with the accompanying drawings wherein like reference numerals denote like elements

FIG. 1 is a general design of the Systems for decentralized blockchain-scheduled container orchestration, repository and code deployment with tokenized tracking.

FIG. 2 is a design of a multi node cluster that is used as a Container Orchestration Environment (COE), which is a node in a Geographically Distributed Container Orchestration System (GDCOS).

FIG. 3 is a design of a single node cluster that is used as a Container Orchestration Environment (COE) node in a Geographically Distributed Container Orchestration System (GDCOS).

FIG. 4 is a design of a Software Defined Virtual Private Network (SDVPN) that creates a unified network infrastructure for all elements part of the Geographically Distributed Container Orchestration System (GDCOS).

FIG. 5 is a method of operation of the Software Defined Virtual Private Network (SDVPN), which is the unified network infrastructure of the Geographically Distributed Container Orchestration System (GDCOS).

FIG. 6 is a method of operation of the Geographically Distributed Container Orchestration System (GDCOS), the Declarative State Document, and the process of triggering the execution of containerized application.

FIG. 7 is a flow diagram of the process of initialization of new user in the system.

### DETAILED DESCRIPTION OF THE INVENTION

Reference will now be made in detail to the exemplary embodiments of the present disclosure, examples of which are illustrated in the accompanying drawings, wherein like reference numerals refer to like elements throughout. The embodiments are described below so as to explain the present disclosure by referring to the figures. Repetitive description with respect to like elements of different exemplary embodiments may be omitted for the convenience of clarity.

In the following description, for purposes of explanation, numerous details are set forth in order to provide a thorough understanding of the invention. It will be apparent, however, to one skilled in the art that the invention can be practiced without these details.

The present disclosure relates generally to cloud computing, and more particularly to a decentralized container orchestration computing environment with code tracking and delivering capability, through a distributed hybrid network, and blockchain in particular.

Broadly, embodiments of the present invention relate to methods and systems for a blockchain-coordinated scheduling of containers across multiple decentralized Container Orchestration Environments COE (103) in combination with Non-Fungible Token Signed Code Repository NFTSCR (106). The NFTSCR (106) is a code repository, where each repository may be signed by a unique NFT (108).

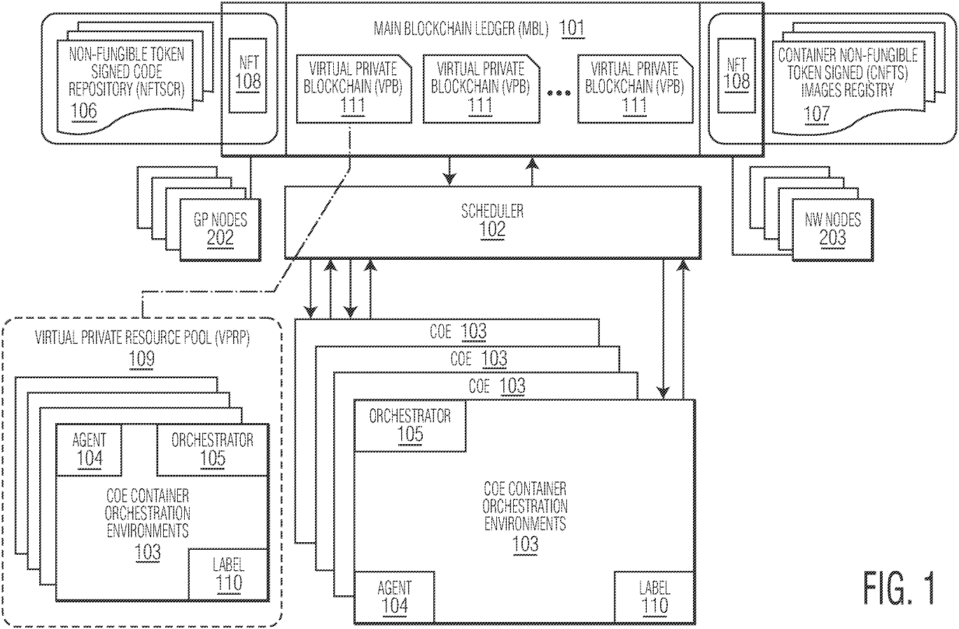

FIG. 1 illustrates the general design of the methods and systems for decentralized blockchain-scheduled container orchestration, repository and code deployment with tokenized tracking. The drawing represents an example design of a globally spanned, Geographically Distributed Container Orchestration System (GDCOS). The system deploys containerized applications in a Container Orchestration Environment (COE) (103) nodes, controlled by Scheduler (102), which holds the data in globally distributed blockchain.

Using the advantage of the blockchain technology and containerized deployment of software, FIG. 1 shows a general design of the Geographically Distributed Container Orchestration System (GDCOS) for a blockchain-coordinated scheduling of containers across multiple decentralized globally distributed Container Orchestration Environments COE (103).

The architecture of methods and systems for decentralized blockchain-scheduled container orchestration, repository and code deployment with tokenized tracking comprises of three type of nodes - General Purpose Nodes - GP Nodes (202), Network Nodes - NW Nodes (203), Container Orchestration Environments COE (103).

The blockchain used in methods and systems for decentralized blockchain-scheduled container orchestration, repository and code deployment with tokenized tracking consist of Main Blockchain Ledger (MBL) (101), that could be a Public Blockchain and/or Virtual Private Blockchains - VPB (111). The Main Blockchain Ledger (MBL) (101) may reside on General Purpose Nodes (202). The MBL (101) keeps track of availability and resource usage in total for the whole system, and for each Container Orchestration Environment COE (103) in particular. One component of the methods and systems is the Non-Fungible Token Signed Code Repository NFTSCR (106), a code repository, where the repository itself and the stored code inside can be signed by unique NFT (108). Each code repository contains a computer executable code. Each NFT (108) may serve as a unique identifier for a code repository and specific code version.

Each element of the “methods and systems” - General Purpose Nodes GP Nodes (202), Network Nodes - NW Nodes (203), Container Orchestration Environments COE (103), NFTSCR (106), CNFTS (107), non-signed container images, executed containers, Users, Agent (104)s - may have an Unique ID (601) stored in the Main Blockchain Ledger (MBL)(101). The Unique ID (601) could be a Private Key, unique username or an authentication token.

The Main Blockchain Ledger (MBL) (101) may also track the execution of non-signed container images and Container Non-Fungible Token Signed CNFTS (107) images. The CNFTS (107) images may consist of computer executable code, taken from Non-Fungible Token Signed Code Repositories NFTSCR (106). The CNFTS (107) images can be signed by NFTs as well, that serve as unique container identifiers. There is also a CNFTS (107) registry that is a part of the decentralized infrastructure. The NFTs (108) used in NFTSCR (106) and CNFTS (107) may be generated by the MBL (101) and can be recorded there.

There may be used a Scheduler (102), a separate component that may use data from the Main Blockchain Ledger (MBL) (101), to orchestrate the execution of CNFTS (107) images and/or non-signed images into COEs (103), in accordance with a predefined set of rules. The Scheduler (102) may reside on the General Purpose Nodes - GP Nodes (202). There may be an element called Orchestrator (105) inside Container Orchestration Environment COE (103). It may orchestrate the execution of containers inside the COE (103), in accordance with the instructions received by the Scheduler (102). There may be installed also a module - Agent (104) that serves as a communication layer between the Scheduler (102) and Orchestrator (105). It may process API calls sent by the Scheduler (102) to the Orchestrator (105) and by the Orchestrator (105) to the Scheduler (102).

The Scheduler (102) may monitor containers’ accessibility, may execute containers liveness and readiness probes and may report back to the blockchain. The Scheduler (102) may also track COEs (103) liveness probe. The Scheduler (102) may check the blockchain for newly registered COEs (103) transactions. Once a new COE (103) is registered in the MBL (101), the Scheduler (102) performs tests in accordance with a predefined set of rules. The Scheduler (102) may also assign internal fully qualified domain names (FQDN), called Service Name. The Scheduler (102) may monitor the MBL (101) for failed COE (103) transactions. In case of a failed COE (103) transaction, The Scheduler (102) checks the system for available resources and starts the containers scheduled to run on the failed COE (103) in other available COEs (103).

The multiple decentralized Container Orchestration Environments COE (103), mentioned above are infrastructure nodes, used to execute computer code. The COE (103) could be a stand-alone virtual or a physical appliance or a cluster of appliances that may consist of CPU/CPUs, memory, operating system, network interfaces, and Agent (104).

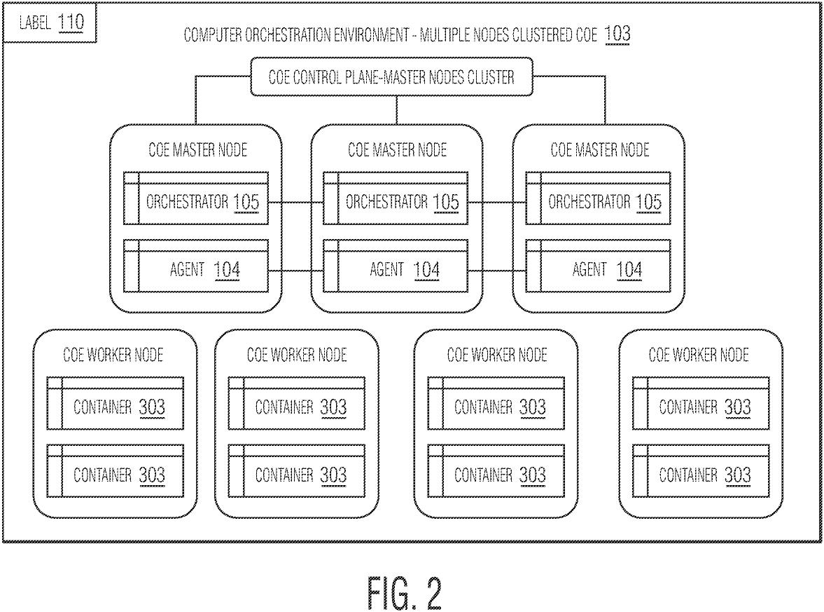

FIG. 2 represents design of a multi node cluster that is used as a Container Orchestration Environment (COE) (103) that may be used as a node in a Geographically Distributed Container Orchestration System (GDCOS).

More specifically, FIG. 2 shows a schematic representation of a Multiple Nodes Container Orchestration Environments COE (103). The Container Orchestration Environment COE (103) is a system that may run and orchestrate internally computer code packaged as a container. Container Orchestration Environments COE (103) are capable of scheduling and orchestrating the containers internally in the COE (103), while coordinating the desired number of active containers as requested by the system Scheduler (102). For one of ordinary skill in the art it should be obvious that any form of container orchestration technology, for example Kubernetes cluster can be used for Multiple Nodes Container Orchestration Environment COE (103).

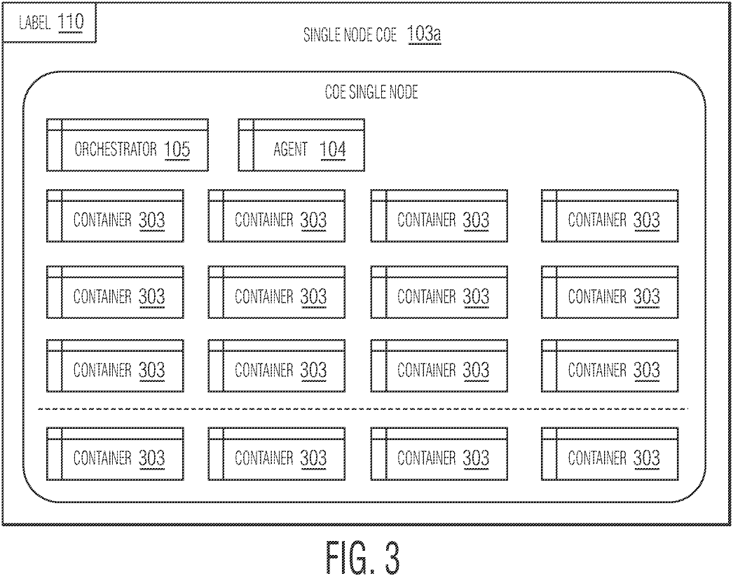

FIG. 3 shows a schematic representation of a Single Node Container Orchestration Environment COE (103a). The Single Node Container Orchestration Environment COE (103a) is a system that may run computer code packaged as a container. The Single Node Container Orchestration Environment COE (103a) is capable of scheduling containers in the COE (103a), while coordinating the desired number of active containers as requested by the system’s Scheduler (102). For one of ordinary skills in the art it should be obvious that any form of container technology, for example Docker, Single Node Kubernetes and etc. can be used for a Single Node Container Orchestration Environment COE (103a).

The Agent (104) may be a module that can connect the COE (103) to the blockchain and The Scheduler (102). The Agent (104) may be a piece of computer code that allows the COE (103) to report to the MBL (101) and The Scheduler (102). Each COE (103) may have its own Orchestrator (105). The Orchestrator (105) manages the execution of non-signed container images and/or Container Non-Fungible Token Signed CNFTS (107) images inside the COE (103). All COE (103) Orchestrators (105) may receive container execution parameter instructions from the Scheduler (102). Each Orchestrator (105) may assign network addresses to the executed non-signed containers and/or CNFTS (107). Each COE (103) may receive a unique ID from the MBL (101). The COEs (103) may also have attributes called Labels (110). The Scheduler (102) may use Labels (110) to orchestrate the container’s execution throughout the whole system for decentralized blockchain-scheduled container orchestration.

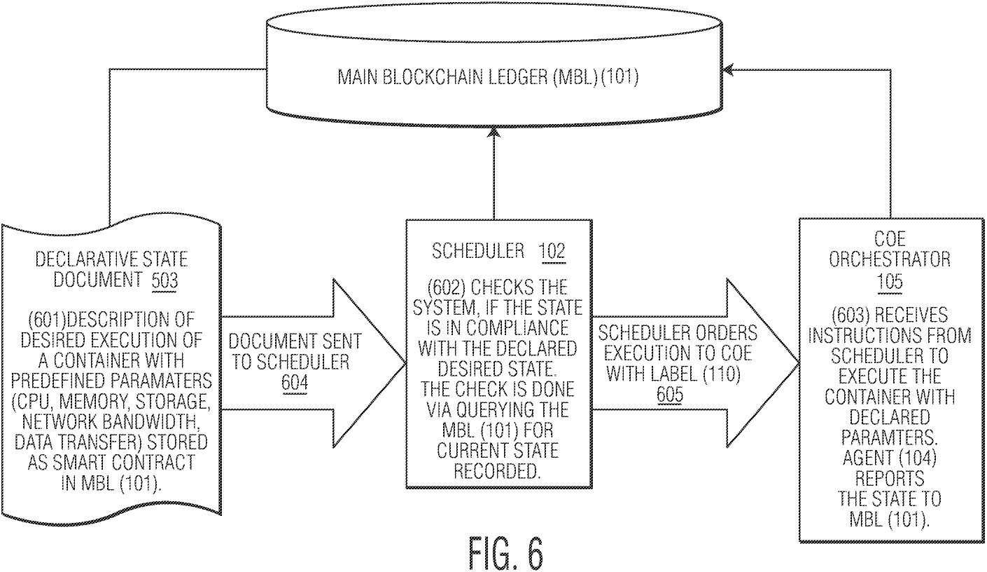

An example is pictured in FIG. 6. The drawing describes basic method of operation of the Geographically Distributed Container Orchestration System (GDCOS) namely the optional use of Declarative State Document (503), that may store the desired state of the of desired execution of a container with predefined parameters (CPU, Memory, Storage, Network Bandwidth, Data Transfer) The Declarative State Document (503) can be stored as smart contract in MBL (101). For one of ordinary skill in the art it should be obvious that the Declarative State Document (503) can be in form of YAML, JSON or other standard computer code document format. The process flow may start with the event of the user creating a description (601) of the desired containerized application parameters. The description may be stored in MBL (101), as a Declarative state document (503).

A notification (604) for a new Declarative State Document (503) is sent to Scheduler (102). Process (602) check is performed by Scheduler (102), whether the state is in compliance with the declared desired state. The check can be performed by querying the API of the system for current state recorded. If the declared desired state conditions are not met, with event (605) Scheduler (102) orders execution to COE (103), by sending API calls to Agent (104) running on COE’s (103) . The COEs (103) to which the API call is sent, are selected by the Labels (110) defined in Declarative state document (503). With event (603), COE’s Orchestrator (105) may receive instructions from Scheduler (102) via Agent (104) to execute the container with declared parameters. Agent (104) may report the state back to MBL (101). For one of ordinary skills in the art it should be obvious that any form of communication between Agents (104), Orchestrators (105) and Scheduler (102) can be implemented via application programming interface (API) calls or other means of communication between computer systems.

The Main Blockchain Ledger - MBL (101) can be distributed on a number of General Purpose Nodes - GP Nodes (202) that may run on top of a public network. These nodes host the MBL (101). A GP Node (202) may also run as a container inside the COE (103). There also may be a private network, deployed on the Network Nodes - NW Nodes (203). The - NW Nodes (203) may also hold the networking configuration and the current network state. The -NW Nodes (203) may also hold configuration of a Virtual Private Blockchain - VPB (111). VPB (111) is a method for defining a private blockchain. The VPB (111) may interconnect with the Main Blockchain Ledger-MBL (101). The VPB (111) entries may be encrypted with secondary private keys for each user. The purpose of the encryption is to restrict the access to any data stored in the Virtual Private Blockchain - VPB (111) only to VPB’s (111) private key owner. The VPB (111) allows logical isolation of resources, thus may be used for creating a form of a secured Virtual Private Resource Pool — VPRP (109). The VPRP (109) is accessible by the VPB (111) key holder only. Example of the Virtual Private Resource Pool — VPRP (109) design is shown on FIG. 1

The methods and systems for decentralized blockchain-scheduled container orchestration, repository and code deployment with tokenized tracking, provide for the use of decentralized built-in logging and decentralized alerting system.

The Agent (104) in each Container Orchestration Environment (COE) 103) may report consumed and unconsumed COEs (103) resources (CPU, Memory, Storage, Network Bandwidth, Data Transfer) to the Main Blockchain Ledger (MBL) (101). The Agent (104) may log COEs (103) resource utilization in the MBL (101). Each COE’s (103) Agent (104) may monitor liveness probes of a specific number of other COEs (103). The Agent (104) may track all containers that run inside the COE (103). The Agent (104) may track containers’ resource utilization (CPU, Memory, Storage, Network Bandwidth, Data Transfer) inside the COE (103). The Network Nodes (NW) may collect statistics for consumed bandwidth and data transfer and may store it in the Virtual Private Blockchain (VPB) and/or in the Main Blockchain Ledger - MBL (101).

There also may be used an element of the “methods and systems” called Validator. The Validator can be a computer code that runs on GP Nodes (202). In case of a failed COE (103), two Agents (104) report to random odd number of Validators. Based on consensus of Validators, a transaction that contains the ID of the failed COE (103) is sent to the MBL (101).

The methods and systems for decentralized blockchain-scheduled container orchestration, repository and code deployment with tokenized tracking provide for a software used to track changes in a set of files (e.g., Git). It may be fulfilled as Non-Fungible Token Signed Code Repository (NFTSCR) (106). When a new NFTSCR (106) is initialized, a unique NFT is generated and recorded in the MBL (101). When a contributor joins the NFTSCR (106), an NFT is generated for them. During the initialization process the NFTSCR’s (106) owner has an option to define a decentralized autonomous organization DAO (703) for reward distribution to the eventual contributors.

The networking of the methods and systems for decentralized blockchain-scheduled container orchestration, repository and code deployment with tokenized tracking may consist of combination of the above defined Network Nodes (NW); Main Blockchain Ledger (MBL) (101); a decentralized Software Defined Virtual Private Network (SDVPN) software application that runs on NW Nodes, creates and delivers the networking service; a Replication Agent (104) (RA) that makes the NW Nodes to work in cluster mode. Those elements may form a global decentralized mesh network infrastructure. For one of ordinary skill in the art it should be obvious that any other form of mesh network or standard computer network can be used for internal communication in the system.

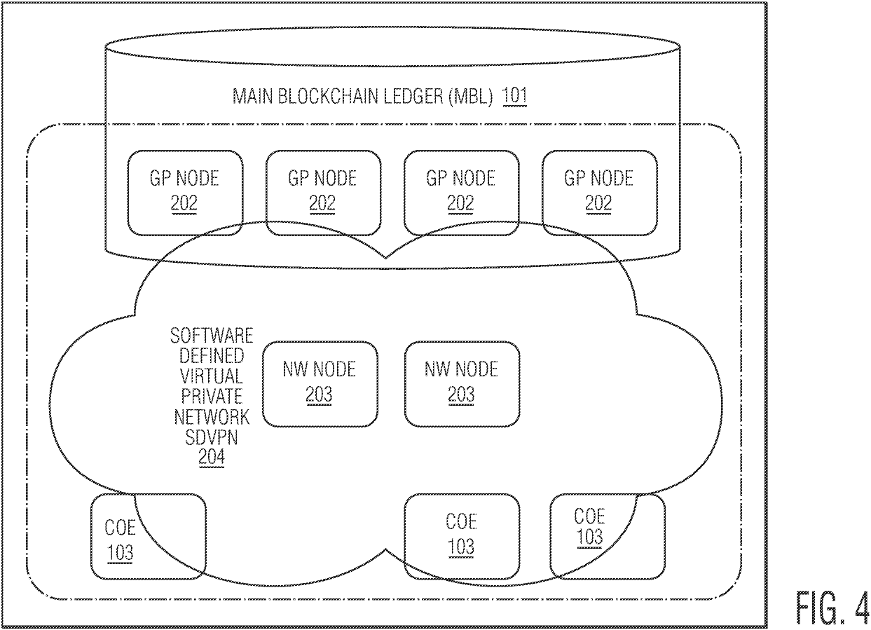

FIG. 4 represents a design of a Software Defined Virtual Private Network (SDVPN) (204) that may create a unified network infrastructure for all elements part of the Geographically Distributed Container Orchestration System (GDCOS). MBL (101) may reside on the General Purpose Nodes (202). The software that enables the SDVPN (204) operations may resides on the Network Nodes (203). Software Defined Virtual Private Network (SDVPN) may connect the General Purpose nodes - GP Nodes (202) on which resides a blockchain. The network core are the Network Nodes - NW Nodes (203). The SDVPN (204) may create a unified network infrastructure for the Geographically Distributed Container Orchestration System (GDCOS).

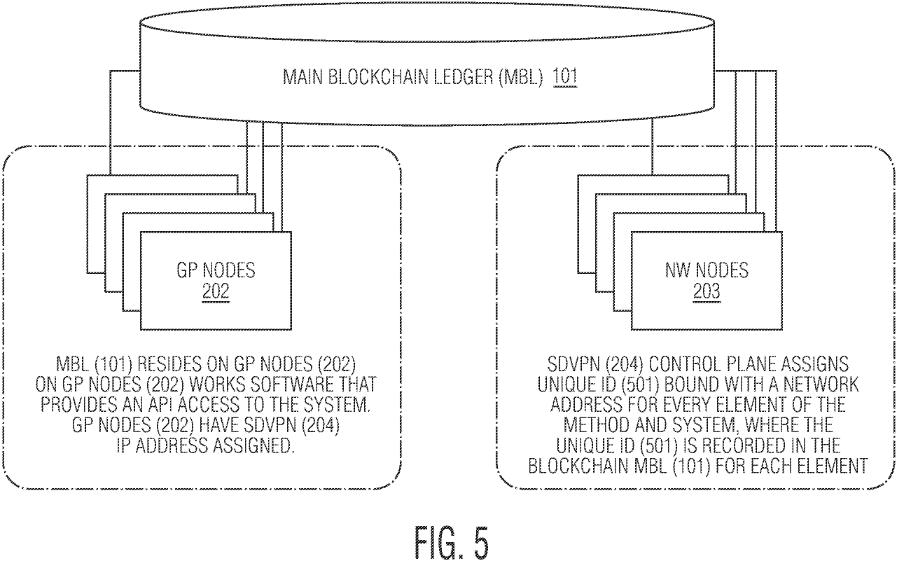

FIG. 5 represents a basic method of operation of the SDVPN (204), the unified network infrastructure for the Geographically Distributed Container Orchestration System (GDCOS). The decentralized Software Defined Virtual Private Network - SDVPN (204) mentioned above may run on the NW Nodes (203). The SDVPN (204) software implementation may use the MBL (101) as a datastore that holds the Unique ID (501) of all elements, part of the Methods and systems for decentralized blockchain-scheduled container orchestration, repository and code deployment with tokenized tracking. When a new element joins the network, the Agent (104) may create a Unique ID (501) and store it in the MBL (101). An example is the initialization of a COE’s (103) Agent (104) when a new COE (103) joins the global decentralized network infrastructure. An identical process — an initialization of a Replication Agent (104) (RA) may create Unique ID (501) for the NW Nodes (203) — this may occur when a NW Node (203) joins the infrastructure.

The Replication Agent (RA) may provide instructions and may assign network settings to the newly joined Network Node (NW) (203).

The Unique ID (501) may be used to identify every element of the methods and systems for decentralized blockchain-scheduled container orchestration, repository and code deployment with tokenized tracking. It also may serve as an identifier in Virtual Private Blockchain - VPB (111).

As previously mentioned the Unique ID could be a Private Key, unique username or an authentication token. The architecture allows a Virtual Private Resource Pool (VPRP) (109) to reside on top of the global decentralized network infrastructure.

FIG. 6 represents a method of operation of the Geographically Distributed Container Orchestration System (GDCOS), the Declarative State Document (503), and how the document may trigger the execution of containerized application.

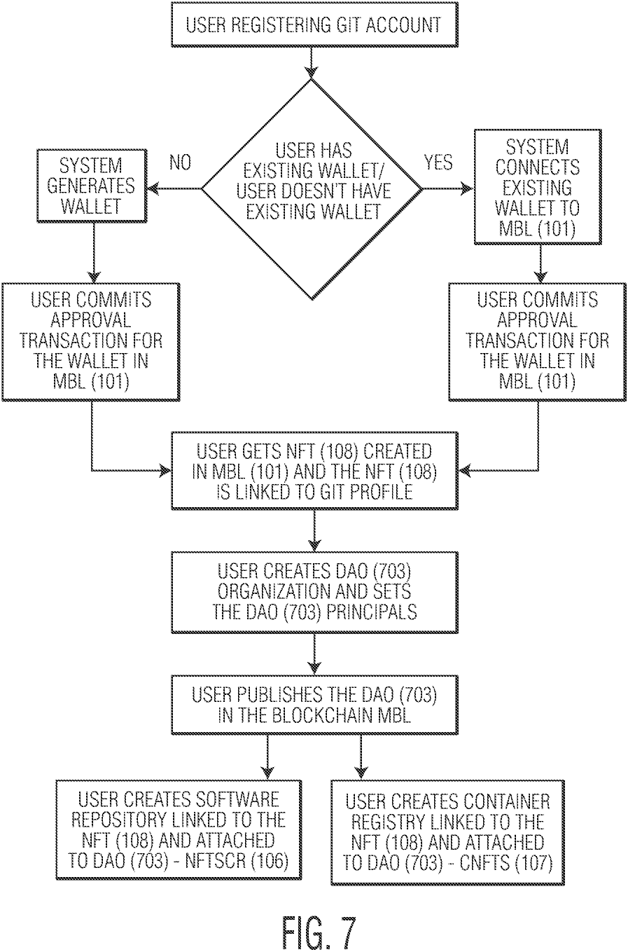

FIG. 7 displays the process of user registration in the Geographically Distributed Container Orchestration System (GDCOS). Upon registration the User may receive a Unique ID (501), a Git account and may be provided with a unique non-fungible token (NFT) (108). Based on the availability of User’s crypto wallet, the system may either create a wallet for the User or may connect an existing wallet to the MBL (101). The next step may be the User to get a unique NFT (108) that can be connected to the User’s Git Profile. Once the User’s NFT (108) is created and connected to their Git Profile, the User has an option to create a DAO (703) and can define DAO principles. Any DAO (703) created by a User is publicly visible in the MBL (101). Any User can create a software repository linked to the NFT (108) and repository may be attached to DAO (703) - NFTSCR (106). The User can create a container registry that is linked to the NFT (108) and may be attached to DAO (703) - CNFTS (107).

NFTSCR (106) owners may receive rewards in digital tokens according to the recorded execution. Furthermore, pieces of code, for example a container image composer file, stored in the different NFTSCR (106), altogether may compose a container that has NFT (108) as a unique identifier - Container Non-Fungible Token Signed (CNFTS) (107). Every code contributor and NFT (108) owner can create their own decentralized autonomous organization DAO (703) on top of the decentralized blockchain and may redistribute reward coins according to the DAO’s (703) articles of organization. This constitutes another embodiment of the invention.

Unless defined otherwise, all technical terms used herein have the same meaning as commonly understood by one of ordinary skill in the art to which this invention belongs. Any methods and materials similar or equivalent to those described herein also can be used in the practice or testing of the present disclosure.

It must be noted that as used herein and in the appended claims, the singular forms “a”, “and”, and “the” include plural references unless the context clearly dictates otherwise.

While the present disclosure has been described with reference to the specific embodiments thereof, it should be understood by those skilled in the art that various changes may be made and equivalents may be substituted without departing from the true spirit and scope of the invention. In addition, many modifications may be made to adopt a particular situation, material, composition of matter, process, process step or steps, to the objective spirit and scope of the present disclosure. All such modifications are intended to be within the scope of the claims appended hereto.

What is claimed is:

1. A computer-implemented system utilizing decentralized blockchain-coordinated scheduling of containers across multiple Container Orchestration Environments (COE) comprising:
a public blockchain,
a Virtual Private Blockchain (VPB),
a decentralized Scheduler,
an Agent,
an Orchestrator internal to said COE, and
a unique ID stored in the blockchain;
wherein said system is implemented through a distributed hybrid mesh network and blockchain controlled scheduling and resource allocation.

2. The system of claim 1, wherein the Container Orchestration Environment (COE) is a single virtual computer.

3. The system of claim 1, wherein the Container Orchestration Environment (COE) is a single physical computer.

4. The system of claim 1, wherein the Container Orchestration Environment (COE) is a cluster of virtual computers.

5. The system of claim 1, wherein the Container Orchestration Environment (COE) is a cluster of physical computers.

6. The system of claim 1, wherein there is an orchestration by blockchain-based Scheduler.

7. The system of claim 1, wherein a datastore used by the Scheduler works on top of a public blockchain.

8. The system of claim 1, wherein a datastore used by the Scheduler works on top of a virtual private blockchain.

9. The system of claim 1, wherein a decentralized, blockchain-coordinated logging and alerting system tracks computing resources provided for each container, that is scheduled by the Scheduler, for execution to a Container Orchestration Environment (COE), and reports back to the Scheduler; and the said system stores the tracking data in the blockchain.

10. The system of claim 1, wherein a decentralized, blockchain-coordinated logging and alerting system monitors the historical data, operational state, and resource allocation of the Container Orchestration Environments (COE).

11. A computer-implemented method utilizing Scheduler that uses blockchain stored data to orchestrate the execution of container images.

12. The method of claim 11, wherein the Scheduler manages an Orchestrator inside the Container Orchestration Environment (COE).

13. The method of claim 11, wherein the executed container images are signed by non-fungible token.

14. The method of claim 11, wherein the executed container images are non-signed.

15. The method of claim 11, wherein Scheduler manages a Virtual Private Resource Pool (VPRP).

16. A computer-implemented method utilizing decentralized Non-Fungible Token (NFT)-signed container delivery and decentralized NFT-signed code delivery; said method allows tokenized tracking of a software code repository and a tokenized tracking of code execution.

17. The method of claim 16, wherein there is a code repository, in which the computer code is signed by a unique NFT.

18. The method of claim 16, wherein there is a container image signed by a unique NFT.

19. The method of claim 16, wherein during an initialization process of a new Non-Fungible Token Signed Code Repository (NFTSCR), a unique NFT is generated and recorded in the Main Blockchain Ledger (MBL).

20. The method of claim 16, wherein during the process of joining of a new contributor to a Non-Fungible Token Signed Code Repository (NFTSCR), an NFT is generated for the contributor.

21. A computer-implemented method utilizing a functionality, where the owner of a Non-Fungible Token Signed Code Repository (NFTSCR) defines a decentralized autonomous organization (DAO) for reward distribution to contributors.

22. A computer-implemented system utilizing an identification system characterized by a Unique ID bound with a network address, where the Unique ID is recorded in the blockchain for each element, where this particular identification system enables a decentralized Software Defined Virtual Private Network (SDVPN).

23. The system of claim 22, wherein the element is Network Node.

24. The system of claim 22, wherein the element is a General Purpose Node.

25. The system of claim 22, wherein the element is Container Registry.

26. The system of claim 22, wherein the element is a Container Orchestration Environment (COE).

27. The system of claim 22, wherein the element is a container that executes inside COE.

28. The system of claim 22, wherein the element is a Non-Fungible Token Signed Code Repository (NFTSCR).

29. The system of claim 22, wherein the element is a Container Non-Fungible Token Signed (CNFTS).

30. The system of claim 22, wherein the element is a Service Name.

31. A computer-implemented system utilizing a Container Non-Fungible Token Signed (CNFTS) images registry.
